(19) United States
(12) Patent Application Publication
(10) Pub. No.: US 2012/0076457 A1
(43) Pub. Date: Mar. 29, 2012

(54) LIGHT GUIDE PILLAR

(75) Inventors: Zhi-Ting Ye, Zaociao Township (TW); Kuo-Jui Huang, Taichung City (TW)

(73) Assignees: WINTEK CORPORATION, Taichung City (TW); WINTEK TECHNOLOGY(H.K) LTD., Dongguan City (CN)

(21) Appl. No.: 13/240,609

(22) Filed: Sep. 22, 2011

(30) Foreign Application Priority Data
Sep. 24, 2010 (TW) 99132424

(51) Int. Cl. G02B 6/26

(52) U.S. Cl. 385/38

(57) ABSTRACT

A light guide pillar is provided. The light guide pillar having an annular surface is a cylinder. The light guide pillar includes a reflective layer and a light incident structure. The reflective layer is disposed at part of the annular surface. The light incident structure is disposed at one end of the light guide pillar. The light incident structure is a structure with single ramp, dual ramps or a V-shaped groove.

This application claims the benefit of Taiwan application Serial No. 099132424, filed Sep. 24, 2010, the subject matter of which is incorporated herein by reference.

### BACKGROUND OF THE INVENTION

1. Field of the Invention

The invention relates in general to a light guide pillar, and more particularly to a cylindrical light guide pillar.

2. Description of the Related Art

Along with the advance in technology, various types of optical products are provided. Of the various optical products, the display normally employs a light guiding object to guide the light source. After the light emitted from the light source enters the light guiding object, the light is guided by the light guiding object to be emitted in a particular direction.

To be in line with product miniaturization, it has become a generally adapted practice to employ slender light guide pillars as light guiding objects. However, the currently used light guiding objects are composed of slender light guide pillars and are still unable to resolve the problem of low light emitting efficiency.

### SUMMARY OF THE INVENTION

The invention is directed to a light guide pillar, which at least reduces light leakage and increases light emitting efficiency for the electronic products using the light guide pillar through the design of the light incident structure.

According to an aspect of the invention, a light guide pillar is provided. The light guide pillar having an annular surface and a central axial line is a cylinder. The light guide pillar includes a reflective layer and a light incident structure. The reflective layer is disposed at part of the annular surface. The light incident structure is disposed at one end of the light guide pillar. The light incident structure has a first light incident surface. The first light incident surface or the extension of the first light incident surface is inclined to a central axial line.

According to another aspect of the invention, a light guide pillar is provided. The light guide pillar having an annular surface and an end is a cylinder. The light guide pillar includes a reflective layer and a light incident structure. The reflective layer is disposed at part of the annular surface. The light incident structure is disposed at the end. The light incident structure is a structure with single ramp, dual ramps or V-shaped grooves.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a light guide pillar according to a first embodiment of the invention;

FIG. 2 shows a cross-sectional view of the light guide pillar of FIG. 1 viewed along a dotted line 2′;

FIG. 3 shows a light guide pillar according to a second embodiment of the invention;

FIG. 4 shows a cross-sectional view of the light guide pillar of FIG. 3 viewed along a dotted line 4′;

FIG. 5 shows a cross-sectional view of the light guide pillar of FIG. 3 viewed along a dotted line 5′;

FIG. 6 shows a light guide pillar according to a third embodiment of the invention;

FIG. 7 shows a cross-sectional view of the light guide pillar of FIG. 6 viewed along a dotted line 7′;

FIG. 8 shows a light guide pillar according to a fourth embodiment of the invention;

FIG. 9 shows a cross-sectional view of the light guide pillar of FIG. 8 viewed along a dotted line 9′;

FIG. 10 shows a light guide pillar according to a fifth embodiment of the invention;

FIG. 11 shows a cross-sectional view of the light guide pillar of FIG. 10 viewed along a dotted line 11′;

FIG. 12 shows a light guide pillar according to a sixth embodiment of the invention; and

FIG. 13 shows a cross-sectional view of the light guide pillar of FIG. 12 viewed along a dotted line 13′.

### DETAILED DESCRIPTION OF THE INVENTION

A number of embodiments are disclosed below for elaborating the invention. However, the embodiments of the invention are for detailed descriptions only, not for limiting the scope of protection of the invention. Furthermore, secondary elements are omitted in the accompanying diagrams of the embodiments for highlighting the technical features of the invention.

### First Embodiment

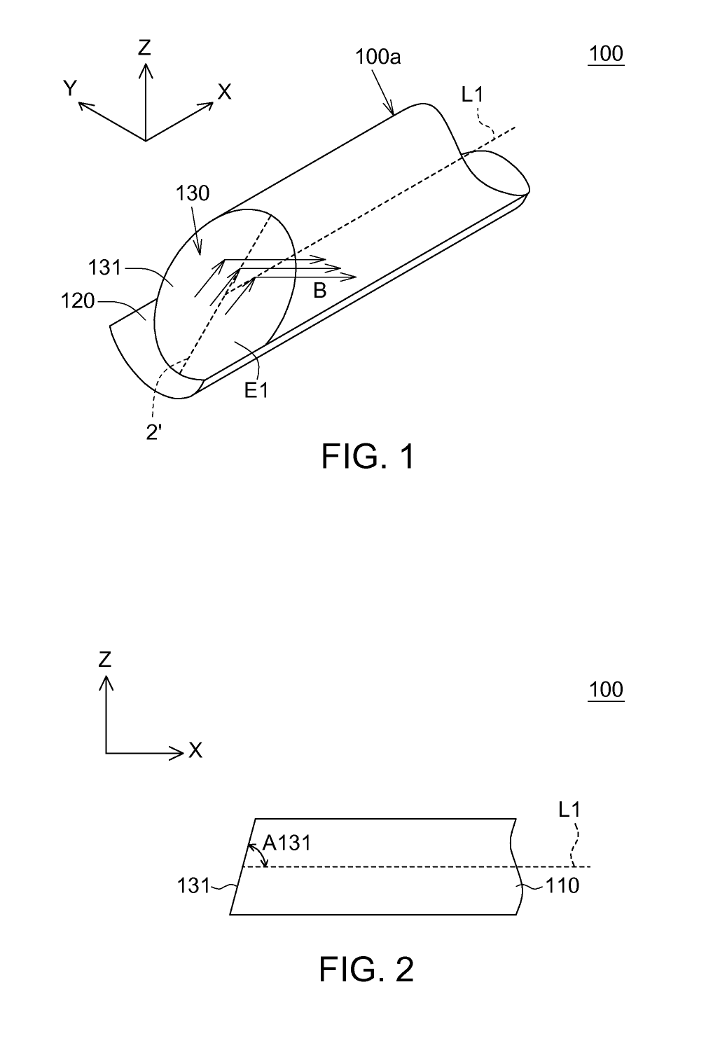

Referring to FIG. 1, a light guide pillar 100 according to a first embodiment of the invention is shown. The light guide pillar 100 having an annular surface 100a and a central axial line L1 is a cylinder. The light guide pillar 100 includes a reflective layer 120 and a light incident structure 130. The light guide pillar 100 guides the light emitted from a light emitting diode (not illustrated). The light guide pillar 100 is made from such as polymethylmethacrylate (PPMA), polycarbonate (PC), polyester (PET) or glass. The reflective layer 120 is disposed at part of the annular surface 100a. The reflective layer 120 is realized by such as a white paint layer or a metal layer. The light incident structure 130 is disposed at an end E1 of the light guide pillar 100. The light emitting diode is disposed outside the light incident structure 130, and the light emitted from the light emitting diode enters the light guide pillar 100 via the light incident structure 130, and then is reflected outwards via the reflective layer 120.

As indicated in FIG. 1, the light incident structure 130 of the present embodiment of the invention merely has a first light incident surface 131, which is inclined to the central axial line L1 to form a structure with single ramp.

Referring to FIGS. 1 and 2. FIG. 2 shows a cross-sectional view of the light guide pillar 100 of FIG. 1 viewed along a dotted line 2′. Since the first light incident surface 131 is a flat plane, when the incident light B of the light emitting diode enters the first light incident surface 131, the light is reflected to the reflective layer 120 via the first light incident surface 131 in a parallel manner instead of being deflected to the outside. Thus, light leakage is reduced, and the density of the light which is emitted from the light emitting diode and enters the reflective layer 120 is increased, so that the light utilization rate is increased, and the light emitted from the light guide pillar 100 has better light emitting efficiency.

Referring to Table 1, the relationship between the included angle A131 and the luminance is shown. The included angle A131 is defined as the included angle between the first light incident surface 131 and the central axial line L1. The experiments show that when the included angle A131 progressively decreases to 73 degrees from 90 degrees (that is, the first light incident surface 131 is more inclined towards the central axial line L1), the average luminance progressively increases to 223.81 luminance (lm) from 210.89 luminance (lm). When the included angle A131 is 75 degrees, the central point luminance reaches an optimum value, that is, 290.77 lm. Thus, when the included angle A131 between the first light incident surface 131 and the central axial line L1 ranges between 73 to 79, better light emitting efficiency is achieved. Preferably, the included angle A131 between the first light incident surface 131 and the central axial line L1 is substantially 75 degrees, better average luminance and central point luminance can both be achieved.

TABLE 1

| Included | | Central |
|---|---|---|
| Angle | Average | Point |
| A131 | Luminance | Luminance |
| 90 degrees | 210.89 lm | X |
| 79 degrees | 216.54 lm | X |
| 77 degrees | 220.17 lm | 287.72 lm |
| 75 degrees | 222.06 lm | 290.77 lm |
| 73 degrees | 223.81 lm | 288.69 lm |

### Second Embodiment

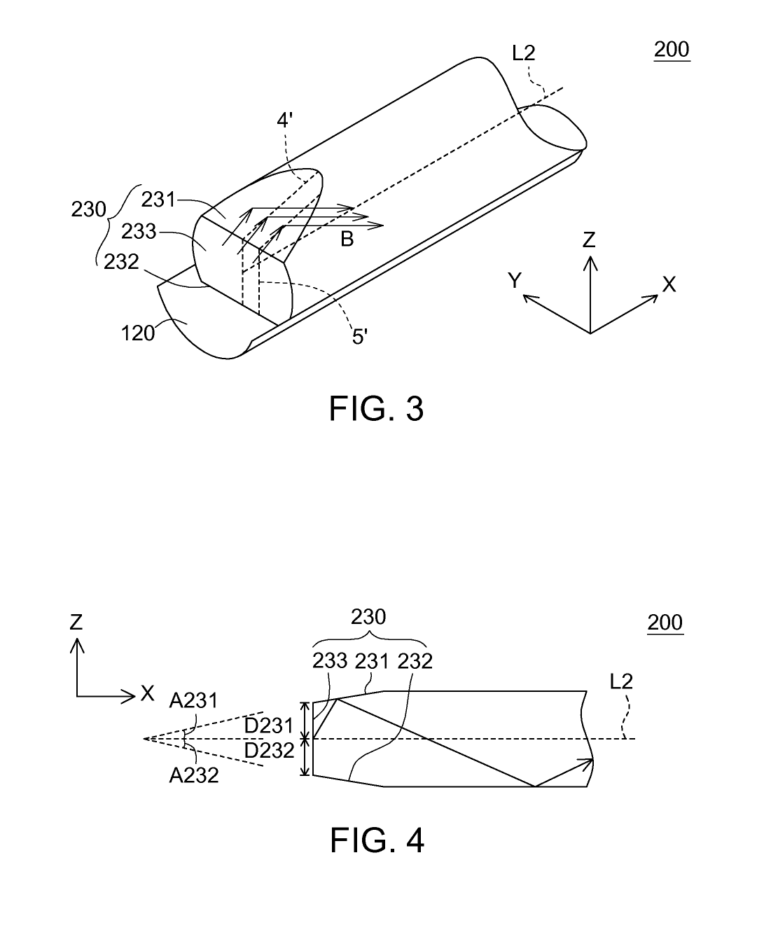

Referring to FIG. 3, a light guide pillar 200 according to a second embodiment of the invention is shown. The light guide pillar 200 of the present embodiment of the invention is different from the light guide pillar 100 of the first embodiment in the design of the light incident structure 230, and the similarities are not repeated here.

As indicated in FIG. 3, the light incident structure 230 of the present embodiment of the invention has a first light incident surface 231, a second light incident surface 232 and a third light incident surface 233. The third light incident surface 233 connects the first light incident surface 231 and the second light incident surface 232. The third light incident surface 233 is substantially perpendicular to a central axial line L2. The first light incident surface 231 and the extension of the second light incident surface 232 are respectively inclined to the central axial line L2 to form two structures with single ramp.

Referring to FIG. 4, a cross-sectional view of the light guide pillar 200 of FIG. 3 viewed along a dotted line 4′ is shown. A cross-sectional view of the light incident structure 230 shows a trapezoidal structure. The first light incident surface 231 and the second light incident surface 232 form a symmetric structure. That is, the included angle A231 between the extension of the first light incident surface 231 and the central axial line L2 is substantially equal to the included angle A232 between the extension of the second light incident surface 232 and the central axial line L2, and the distance D231 from the left end-point of the first light incident surface 231 to the central axial line L2 is substantially equal to the distance D232 from the left end-point of the second light incident surface 232 to the central axial line L2.

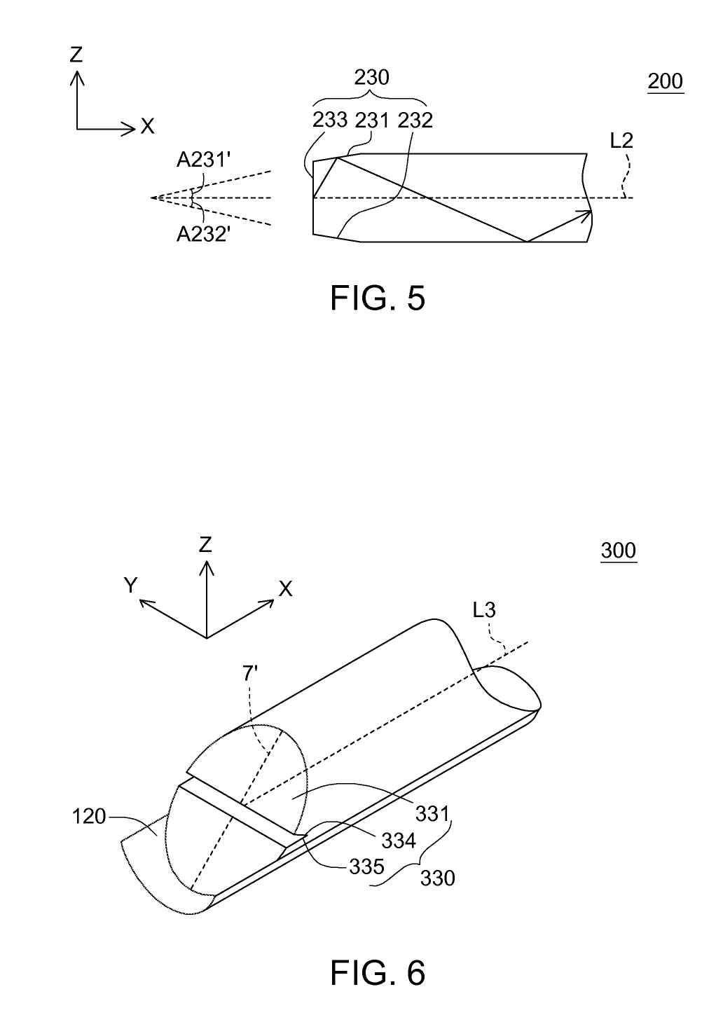

Referring to both FIG. 4 and FIG. 5. FIG. 5 shows a cross-sectional view of the light guide pillar 200 of FIG. 3 viewed along a dotted line 5′. As indicated in FIGS. 4 and 5, the included angle A231 between the extension of the first light incident surface 231 and the central axial line L2 as illustrated in FIG. 4 is substantially equal to the included angle A231′ between the extension of the first light incident surface 231 and the central axial line L2 as illustrated in FIG. 5. The included angles A231 and A231′ between the extension of the first light incident surface 231 and the central axial line L2 do not vary with the position of cross-section. Likewise, the included angles A232 and A232′ between the extension of the second light incident surface 232 and the central axial line L2 do not vary with the position of cross-section either.

Thus, no matter the light emitted from the light emitting diode enters which position of cross-section via the light incident structure 230, the light can enter the reflective layer 120 of the light guide pillar 200 at the same reflection angle without causing any light leakage. For a conic type light incident structure, when the position of cross-section differs, the included angle between the extension of the light incident surface and the central axial line varies accordingly. Thus, when the light emitted from the light emitting diode enters the light guide pillar via the conic type light incident structure, the light may be reflected outwards via the conic type light incident structure and cannot be totally concentrated on the reflective layer 120, hence incurring serious light leakage and deteriorated light utilization rate.

### Third Embodiment

Referring to FIG. 6, a light guide pillar 300 according to a third embodiment of the invention is shown. The light guide pillar 300 of the present embodiment of the invention is different from the light guide pillar 100 of the first embodiment in that the light incident structure 330 of the present embodiment of the invention further has a fourth light incident surface 334 and a fifth light incident surface 335 in addition to a first light incident surface 331, and the similarities are not repeated here.

As indicated in FIG. 6, the fourth light incident surface 334 of the present embodiment of the invention connects the fifth light incident surface 335 to form a V-shaped groove, and the fourth light incident surface 334 and the fifth light incident surface 335 are both inclined to central axial line L3. The surfaces of the first light incident surface 331, the fourth light incident surface 334 and the fifth light incident surface 335 are not parallel with one another.

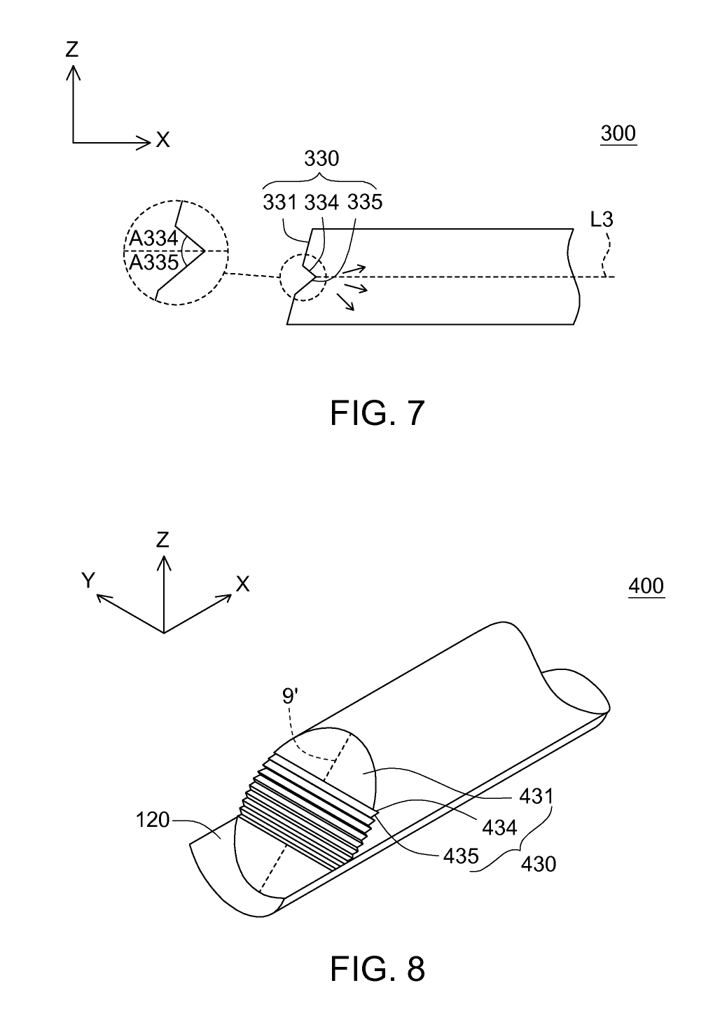

Referring to FIG. 7, a cross-sectional view of the light guide pillar 300 of FIG. 6 viewed along a dotted line 7′ is shown. The light incident structure 330 forms a V-shaped cross-sectional structure on the fourth light incident surface 334 and the fifth light incident surface 335. The included angle A334 of present embodiment of the invention between the fourth light incident surface 334 and the central axial line L3 is substantially equal to the included angle A335 between the fifth light incident surface 335 and central axial line L3. Preferably, the included angle A334 between the fourth light incident surface 334 and the central axial line L3 is substantially 45 degrees, and the included angle A335 between the fifth light incident surface 335 and the central axial line L3 is also 45 degrees. Through the design of the fourth light incident surface 334 and the fifth light incident surface 335, when the light emitted from the light emitting diode being a collimated light enters the light incident structure 330, the light is appropriately diffused to avoid the light being directly emitted to another end of the light guide pillar 300.

### Fourth Embodiment

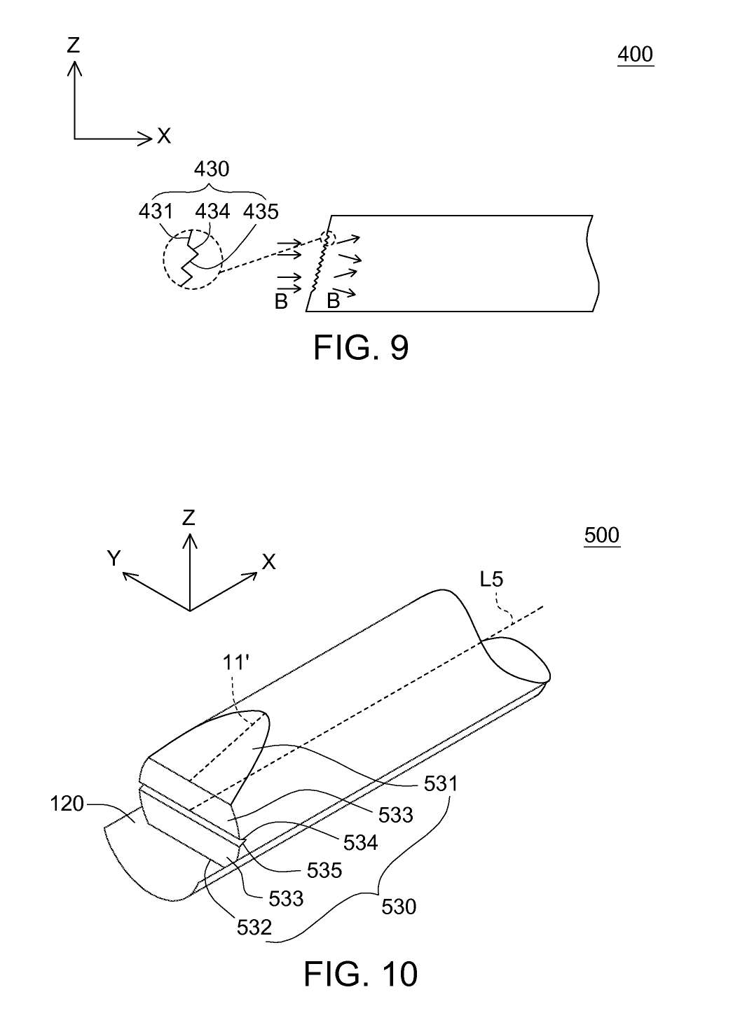

Referring to FIGS. 8 and 9. FIG. 8 shows a light guide pillar 400 according to a fourth embodiment of the invention. FIG. 9 shows a cross-sectional view of the light guide pillar 400 of FIG. 8 viewed along a dotted line 9′. The light guide pillar 400 of the present embodiment of the invention is different the light guide pillar 300 of the third embodiment in the quantities of the fourth light incident surfaces 434 and the fifth light incident surfaces 435, and the similarities are not repeated here.

The light incident structure 430 of the present embodiment of the invention includes a first light incident surface 431, a plurality of fourth light incident surfaces 434 and a plurality of fifth light incident surfaces 435. The fourth light incident surfaces 434 and the fifth light incident surfaces 435 are interlaced to form a saw toothed structure. Through the design of the saw toothed structure, the collimated light emitted from the light emitting diode is immediately diffused when entering the light incident structure 430 to avoid the light being directly emitted to another end of the light guide pillar 400.

### Fifth Embodiment

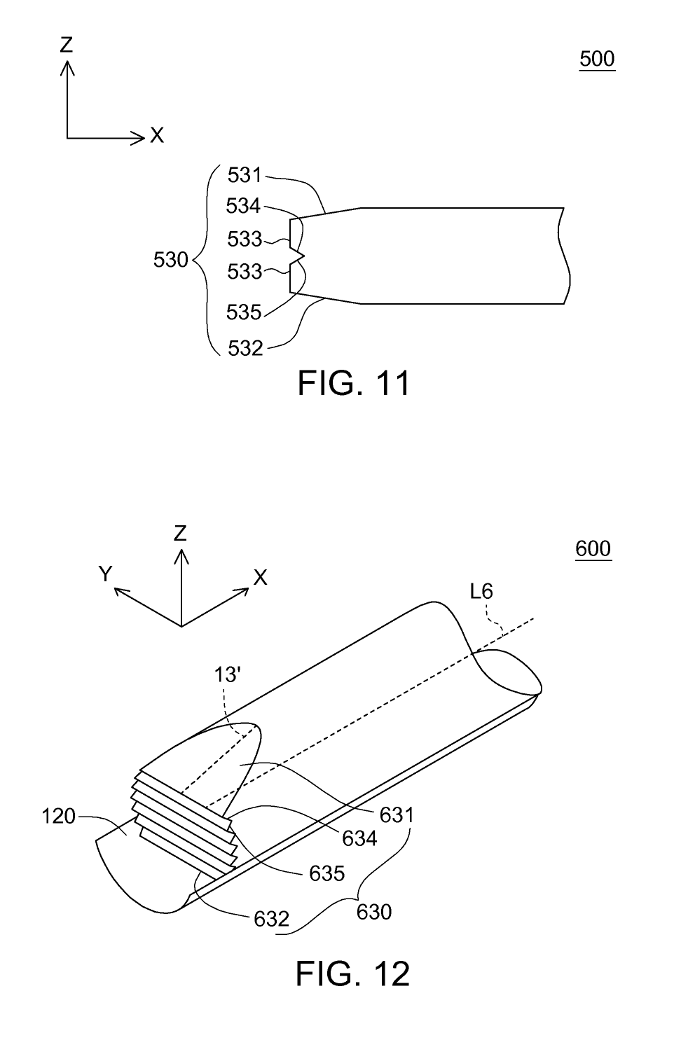

Referring to FIGS. 10 and 11. FIG. 10 shows a light guide pillar 500 according to a fifth embodiment of the invention. FIG. 11 shows a cross-sectional view of the light guide pillar 500 of FIG. 10 viewed along a dotted line 11′. The light guide pillar 500 of the present embodiment of the invention combines the design of the first to the third light incident surfaces 231, 232 and 233 of the second embodiment and the design of the fourth and the fifth light incident surfaces 334 and 335 of the third embodiment, and the similarities are not repeated here.

The light incident structure 530 of the present embodiment of the invention has a first light incident surface 531, a second light incident surface 532, two third light incident surfaces 533, a fourth light incident surface 534 and a fifth light incident surface 535. The design of the first to the third light incident surfaces 531, 532 and 533 is similar to the design of the first to the third light incident surfaces 231, 232 and 233 of the second embodiment. The design of the fourth and the fifth light incident surfaces 534 and 535 is similar to the design of the fourth and the fifth light incident surfaces 334 and 335 of the third embodiment. The extension of the first light incident surface 531 is inclined to a central axial line L5, and the extension of the second light incident surface 532 is inclined to the central axial line L5. The extension of the third light incident surfaces 533 is substantially perpendicular to the central axial line L5. The fourth light incident surface 534 connects the fifth light incident surface 535. The fourth light incident surface 534 and the fifth light incident surface 535 are both inclined to the central axial line L5 to form a V-shaped groove. One of the third light incident surfaces 533 connects the first light incident surface 531 and the fourth light incident surface 534, and another one of the third light incident surfaces 533 connects the second light incident surface 532 and the fifth light incident surface 535.

### Sixth Embodiment

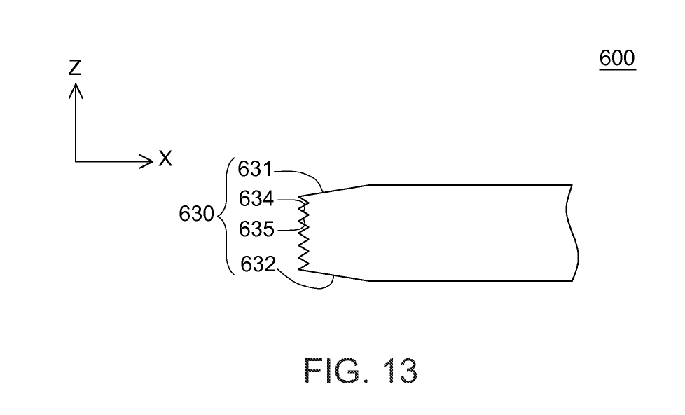

Referring to FIGS. 12 and 13. FIG. 12 shows a light guide pillar 600 according to a sixth embodiment of the invention. FIG. 13 shows a cross-sectional view of the light guide pillar 600 of FIG. 12 viewed along a dotted line 13′. The light guide pillar 600 of the present embodiment of the invention combines the design of the first and the second light incident surfaces 231 and 232 of the second embodiment and the design of the fourth and the fifth light incident surfaces 434 and 435 of the fourth embodiment, and the similarities are not repeated here.

The light incident structure 630 of the present embodiment of the invention has a first light incident surface 631, a second light incident surface 632, a plurality of fourth light incident surfaces 634, and a plurality of fifth light incident surfaces 635. The extension of the first light incident surface 631 is inclined to a central axial line L6, and the extension of the second light incident surface 632 is inclined to the central axial line L6. The first light incident surface 631 connects the topmost fourth light incident surface 634, and the second light incident surface 632 connects the bottommost fifth light incident surface 635. The fourth and the fifth light incident surfaces 634 and 635 are both inclined to the central axial line L6 and fully occupy the predetermined position of the third light incident surface 233 of the second embodiment, so the light incident structure 630 of the present embodiment of the invention lacks the third light incident surface 233 of the second embodiment.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light guide pillar having an annular surface and a central axial line, wherein the light guide pillar is a cylinder and comprises:
a reflective layer disposed at part of the annular surface; and
a light incident structure disposed at one end of the light guide pillar, wherein the light incident structure has a first light incident surface, and the first light incident surface or the extension of the first light incident surface is inclined to the central axial line.

2. The light guide pillar according to claim 1, wherein the light incident structure further has a second light incident surface and a third light incident surface, the third light incident surface connects the first light incident surface and the second light incident surface and is substantially perpendicular to the central axial line, and the extension of the second light incident surface is inclined to the central axial line.

3. The light guide pillar according to claim 2, wherein an included angle between the extension of the first light incident surface and the central axial line is substantially equal to an included angle between the extension of the second light incident surface and the central axial line.

4. The light guide pillar according to claim 1, wherein the light incident structure further has a fourth light incident surface and a fifth light incident surface, the fourth light incident surface connects the fifth light incident surface, and the extension of the fourth light incident surface and the extension of the fifth light incident surface are both inclined to the central axial line to form a V-shaped groove.

5. The light guide pillar according to claim 4, wherein an included angle between the fourth light incident surface and the central axial line is substantially equal to an included angle between the fifth light incident surface and the central axial line.

6. The light guide pillar according to claim 4, wherein an included angle between the fourth light incident surface and the central axial line is substantially 45 degrees, and an included angle between the fifth light incident surface and the central axial line is also substantially 45 degrees.

7. The light guide pillar according to claim 1, wherein the light incident structure comprises a plurality of fourth light incident surfaces and a plurality of fifth light incident surfaces, each of the fourth light incident surfaces or its extension is inclined to the central axial line, each of the fifth light incident surfaces or its extension is inclined to the central axial line, and the fourth light incident surfaces and the fifth light incident surfaces are interlaced to form a saw toothed structure.

8. The light guide pillar according to claim 7, wherein the light incident structure further comprises a second light incident surface, the extension of the second light incident surface is inclined to the central axial line, the first light incident surface connects one of the fourth light incident surfaces, and the second light incident surface connects one of the fifth light incident surfaces.

9. The light guide pillar according to claim 1, wherein the light incident structure further has a second light incident surface, two third light incident surfaces, a fourth light incident surface, a fifth light incident surface, the fourth light incident surface connects the fifth light incident surface, the extension of the fourth light incident surface and the extension of the fifth light incident surface are both inclined to the central axial line to form a V-shaped groove, one of the third light incident surfaces connects the first light incident surface and the fourth light incident surface, the other of the third light incident surfaces connects the second light incident surface and the fifth light incident surface, the extension of the third light incident surfaces is substantially perpendicular to the central axial line, and the extension of the second light incident surface is inclined to the central axial line.

10. The light guide pillar according to claim 1, wherein the included angle between the first light incident surface and the central axial line ranges between 73 to 79 degrees.

11. A light guide pillar having an annular surface and an end, wherein the light guide pillar is a cylinder and comprises:
a reflective layer disposed at part of the annular surface; and
a light incident structure disposed at the end, wherein the light incident structure is a structure with single ramp, dual ramps or a V-shaped groove.
